(19) United States
(12) Patent Application Publication
(10) Pub. No.: US 2026/0342018 A1
(43) Pub. Date: Oct. 29, 2026

(54) CONNECTOR MODULE AND ELECTRONIC DEVICE

(71) Applicant: KYOCERA CORPORATION, Kyoto (JP)

(72) Inventor: Hideharu TAMAI, Sagamihara-shi, Kanagawa (JP)

(21) Appl. No.: 19/111,628

(22) PCT Filed: Sep. 8, 2023
(86) PCT No.: PCT/JP2023/032922

§ 371 Date: Mar. 13, 2025

(30) Foreign Application Priority Data
Sep. 22, 2022 (JP) 2022-151876

(51) Int. Cl. H01R 13/6582; H01R 12/71; H01R 13/115

(52) U.S. Cl. CPC H01R 13/6582; H01R 12/716; H01R 13/115

(57) ABSTRACT

In a connector module 1 according to the present disclosure, a first connector 10 includes a first insulator 20, a plurality of first contacts 30, and a first shield member 40. A second connector 50 includes a second insulator 60, a plurality of second contacts 70, and a second shield member 80. The first shield member 40 includes a pair of first side walls 41, a pair of second side walls 42, and a first end-surface part 44 extending along each of the first side walls 41. The second shield member 80 includes a pair of third side walls 81, a pair of fourth side walls 82, and a second end-surface part 84 extending along each of the third side walls 81. The first end-surface part 44 is positioned at the second connector 50 side with respect to a first end part at the second connector 50 side of each of the second side walls 42, and the second end-surface part 84 is positioned at the first connector 10 side with respect to a second end part at the first connector 10 side of each of the fourth side walls 82.

### CROSS-REFERENCE TO RELATED APPLICATIONS

This application claims priority to Japanese Patent Application No. 2022-151876 filed in Japan on Sep. 22, 2022, which is incorporated herein by reference in its entirety.

### TECHNICAL FIELD The present disclosure relates to a connector module and an electronic device.

### BACKGROUND OF INVENTION

In recent years, measures against electromagnetic noise inside an electronic device have been important. Accordingly, a structure capable of achieving a sufficient noise shielding effect in a connector and a connector module built in an electronic device has been demanded. A known connector includes a shield member, such as a shield, in order to obtain an electromagnetic noise shielding effect.

For example, Patent Literature 1 discloses a connector and a pair of connectors that are small in size and height while being capable of exhibiting high strength and providing a high shielding effect and thus having high reliability.

### CITATION LIST

### Patent Literature

Patent Literature 1: Japanese Unexamined Patent Application Publication No. 2022-029413

### SUMMARY

In an embodiment of the present disclosure, a connector module includes a first connector and a second connector opposed to one another when fitted together. The first connector includes a first insulator, a plurality of first contacts, and a first shield member. The first insulator is fitted to the second connector. The plurality of first contacts is attached to the first insulator. The first shield member is attached to the first insulator. The second connector includes a second insulator, a plurality of second contacts, and a second shield member. The second insulator is fitted to the first connector. The plurality of second contacts is attached to the second insulator. The second shield member is attached to the second insulator. The first shield member includes a pair of first side walls, a pair of second side walls, and a first end-surface part. The pair of first side walls extend in a first direction. The pair of second side walls extend in a second direction intersecting with the first direction. The first end-surface part includes a surface extending along each of the pair of first side walls and facing toward a second connector side when the first connector and the second connector are fitted together while being opposed to one another. The second shield member includes a pair of third side walls, a pair of fourth side walls, and a second end-surface part. The pair of third side walls extend in the first direction. The pair of fourth side walls extend in the second direction. The second end-surface part includes a surface extending along each of the pair of third side walls and facing toward a first connector side when the first connector and the second connector are fitted together while being opposed to one another. While the first connector and the second connector are opposed to one another when fitted together, the first end-surface part is positioned at the second connector side with respect to a first end part at the second connector side of each of the pair of second side walls, and the second end-surface part is positioned at the first connector side with respect to a second end part at the first connector side of each of the pair of fourth side walls.

In an embodiment of the present disclosure, an electronic device includes the connector module described above.

### BRIEF DESCRIPTION OF THE DRAWINGS

FIG. 1 is an external perspective view illustrating a connector module according to an embodiment in top view, with a first connector and a second connector being connected to one another.

FIG. 2 is an external perspective view illustrating a connector module according to an embodiment in top view, with a first connector and a second connector being separated from one another.

FIG. 3 is an external perspective view illustrating the first connector in FIG. 1 alone in top view.

FIG. 4 is an external perspective view illustrating the first connector in FIG. 3 as exploded in top view.

FIG. 5 is a sectional view taken along arrow line V-V in FIG. 3.

FIG. 6 is a front view of the first connector in FIG. 3.

FIG. 7 is a developed view illustrating a first shield member in FIG. 4 before bending in a plate-thickness direction.

FIG. 8 is an external perspective view illustrating the second connector in FIG. 1 alone in top view.

FIG. 9 is an external perspective view illustrating the second connector in FIG. 8 as exploded in top view.

FIG. 10 is a front view of the second connector in FIG. 8.

FIG. 11 is a sectional view taken along arrow line XI-XI in FIG. 1.

FIG. 12 is a sectional view taken along arrow line XII-XII in FIG. 1.

### DESCRIPTION OF EMBODIMENTS

For example, like the connector described in Patent Literature 1, when an upper surface of a shield member is disposed at the same plane as the connector along an outer periphery of the connector, alignment of fitting positions of connectors during fitting between the connectors may be difficult. A reduction in size of the connectors makes such alignment even more difficult. Performing fitting forcibly in such a case may lead to damage to the connector.

In an embodiment of the present disclosure, a connector module and an electronic device can achieve a shield structure that facilitates fitting work between connectors.

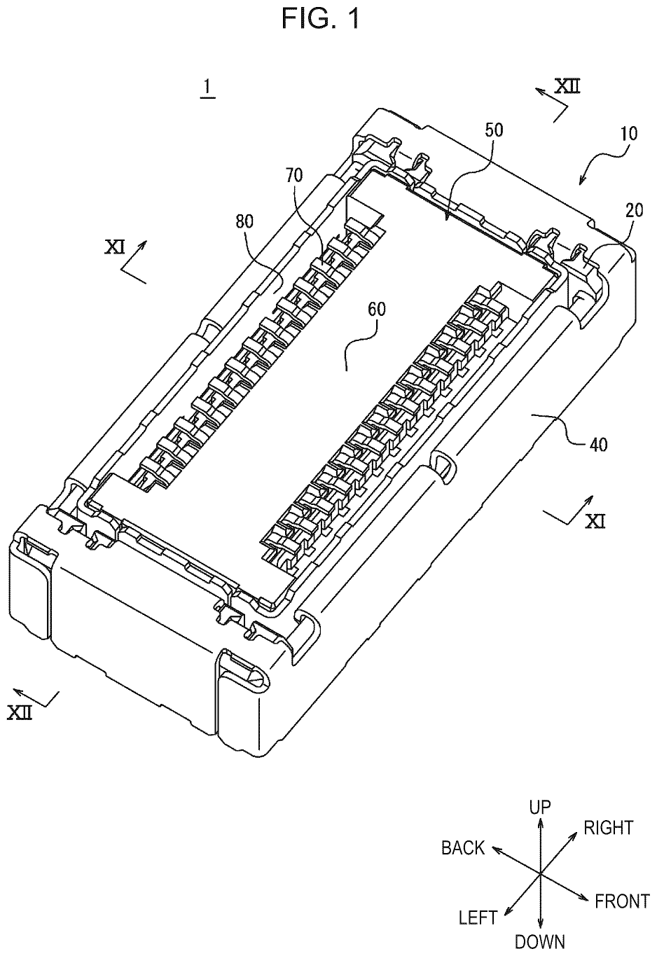

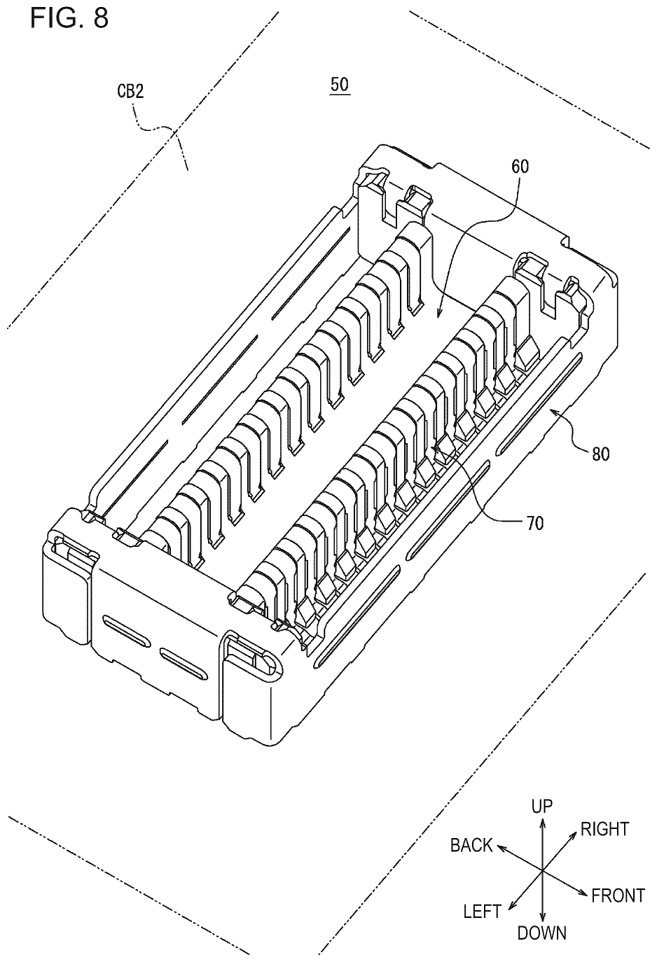

Hereinafter, an embodiment of the present disclosure will be described in detail with reference to the accompanying drawings. A front-back direction, a left-right direction, and an up-down direction in the following description are based on directions of arrows in the drawings. The directions of arrows in FIGS. 1 to 6, 11, and 12 are consistent with each other between different drawings. The directions of arrows in FIGS. 8 to 10 are consistent with each other between different drawings. In some drawings, illustration of circuit boards CB1 and CB2 described later is omitted for the purpose of simplicity of illustration.

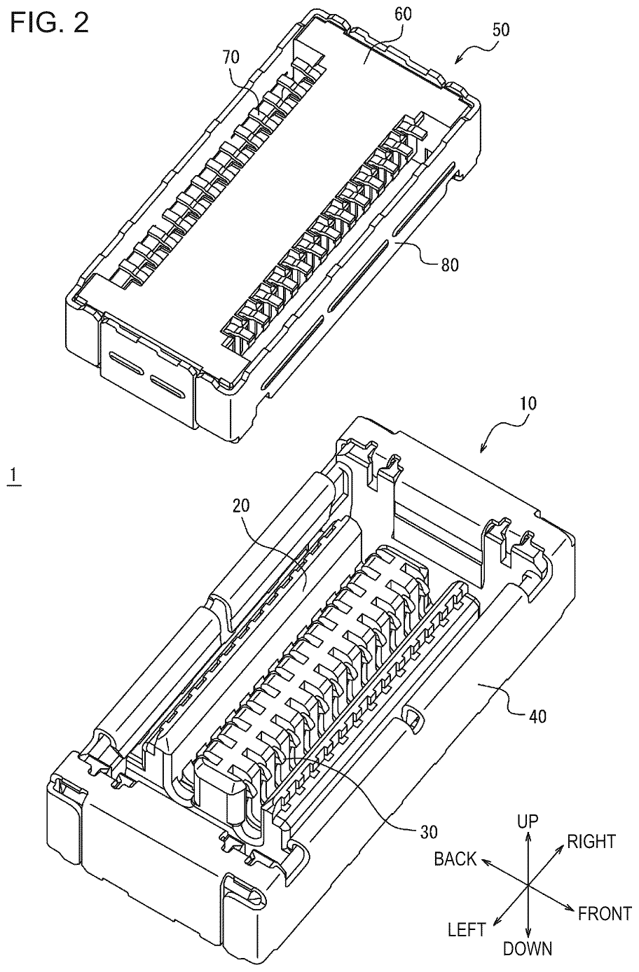

FIG. 1 is an external perspective view illustrating a connector module 1 according to an embodiment in top view, with a first connector 10 and a second connector 50 being connected to one another. FIG. 2 is an external perspective view illustrating the connector module 1 according to an embodiment in top view, with the first connector 10 and the second connector 50 being separated from one another.

For example, as illustrated in FIG. 2, the connector module 1 includes the first connector 10 and the second connector 50, which are fittable to one another. The first connector 10 is connected to a connection target object, with the second connector 50 serving as the connection target object. The first connector 10 includes a first insulator 20 to be fitted to the second connector 50. The first connector 10 includes a plurality of first contacts 30 attached to the first insulator 20. The first connector 10 includes a first shield member 40 attached to the first insulator 20. The first shield member 40 is in contact with a second shield member 80 described later in a fitted state in which the first connector 10 and the second connector 50 are fitted to one another. At this time, the first shield member 40 is elastically deformed.

The second connector 50 is fitted to the first connector 10. The second connector 50 includes a second insulator 60 to be fitted to the first insulator 20 in the fitted state. The second connector 50 includes a plurality of second contacts 70 attached to the second insulator 60. The second contacts 70 are in contact with the first contacts 30 in the fitted state in which the first insulator 20 and the second insulator 60 are fitted to one another. The second connector 50 includes a second shield member 80 attached to the second insulator 60.

For example, according to an embodiment, the first connector 10 is a receptacle connector. For example, according to an embodiment, the second connector 50 is a plug connector. The first connector 10 is described as a receptacle connector if the first contacts 30 are elastically deformable in the fitted state in which the first insulator 20 and the second insulator 60 are fitted to one another. The second connector 50 is described as a plug connector if the second contacts 70 are not elastically deformable in the fitted state. Types of the first connector 10 and the second connector 50 are not limited to those described above. For example, the first connector 10 may serve as a plug connector, and the second connector 50 may serve as a receptacle connector.

The first connector 10 and the second connector 50 are mounted on the circuit boards CB1 and CB2, respectively. The first connector 10 and the second connector 50 electrically connect the circuit board CB1 and the circuit board CB2 in a connected state in which the first connector 10 and the second connector 50 are connected to one another. Each of the circuit boards CB1 and CB2 may be a rigid substrate or any other circuit board. For example, at least one of the circuit board CB1 or the circuit board CB2 may be a flexible printed circuit board (FPC).

The first connector 10 and the second connector 50 are connected to one another in a direction perpendicular to the circuit boards CB1 and CB2. The first connector 10 and the second connector 50 are connected to one another, as one example, in the up-down direction. The connection method is not limited to that described above. The first connector 10 and the second connector 50 may be connected to one another in a direction parallel to the circuit boards CB1 and CB2. The first connector 10 and the second connector 50 may be connected to one another while one of the connectors is perpendicular to the circuit board on which it is mounted, and the other one of the connectors is parallel to the circuit board on which it is mounted.

In the present disclosure, “fitting direction” corresponds to the up-down direction as one example. “Longitudinal direction” corresponds to the left-right direction as one example. “Arrangement direction” corresponds to the left-right direction as one example. “Transverse direction” corresponds to the front-back direction as one example. “Fitting side” corresponds to a lower side as one example. “Removal side” corresponds to an upper side as one example.

“First direction” is the transverse direction of the connector module 1 as one example. “Second direction” is the longitudinal direction of the connector module 1 as one example. “Third direction” corresponds to the up-down direction as one example.

In the present disclosure, “first connector 10 side” corresponds to a direction toward the first connector 10 when the first connector 10 and the second connector 50 are opposed to one another. For example, in FIG. 8 described later, in which the second connector 50 is set as a reference, the first connector 10 side corresponds to the upper side as one example. “Side opposite to the first connector 10 side” is the opposite of the first connector 10 side.

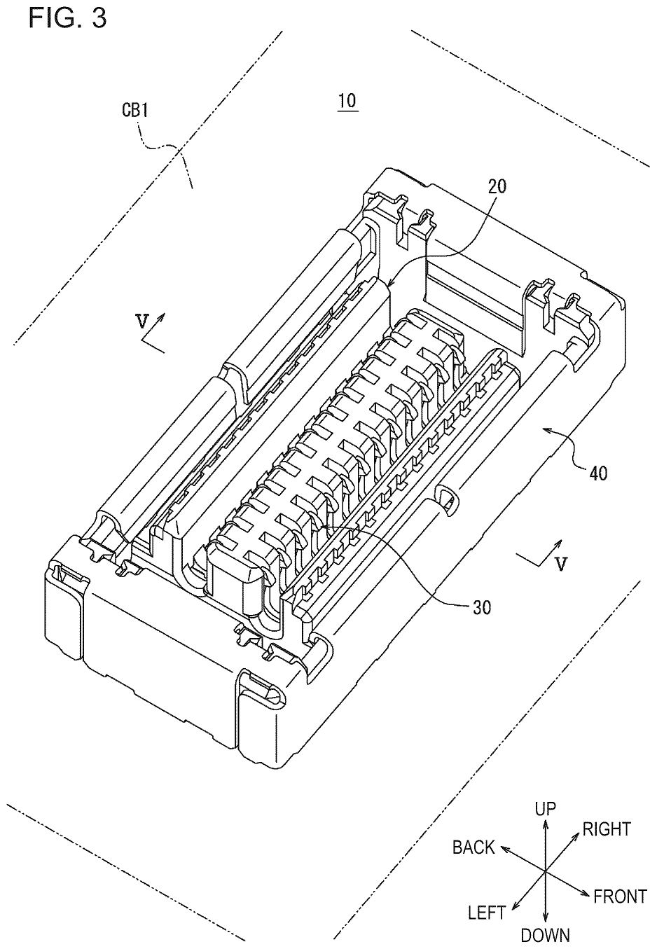

In the present disclosure, “second connector 50 side” corresponds to a direction toward the second connector 50 when the first connector 10 and the second connector 50 are opposed to one another. For example, in FIG. 3 described later, in which the first connector 10 is set as a reference, the second connector 50 side corresponds to the upper side as one example. “Side opposite to the second connector 50 side” is the opposite of the second connector 50 side.

“Inner side” corresponds to a direction toward a center of the first connector 10 or the second connector 50. For example, an inner side in the front-back direction corresponds to a direction toward a center in the front-back direction of the first connector 10 or the second connector 50. The inner side is not limited thereto, that is, does not necessarily correspond to a direction exactly toward a center in the front-back direction, but may correspond to a direction toward a center with a slight inclination. This also applies in the same and/or similar manner to another direction. “Outer side” is the opposite of the inner side.

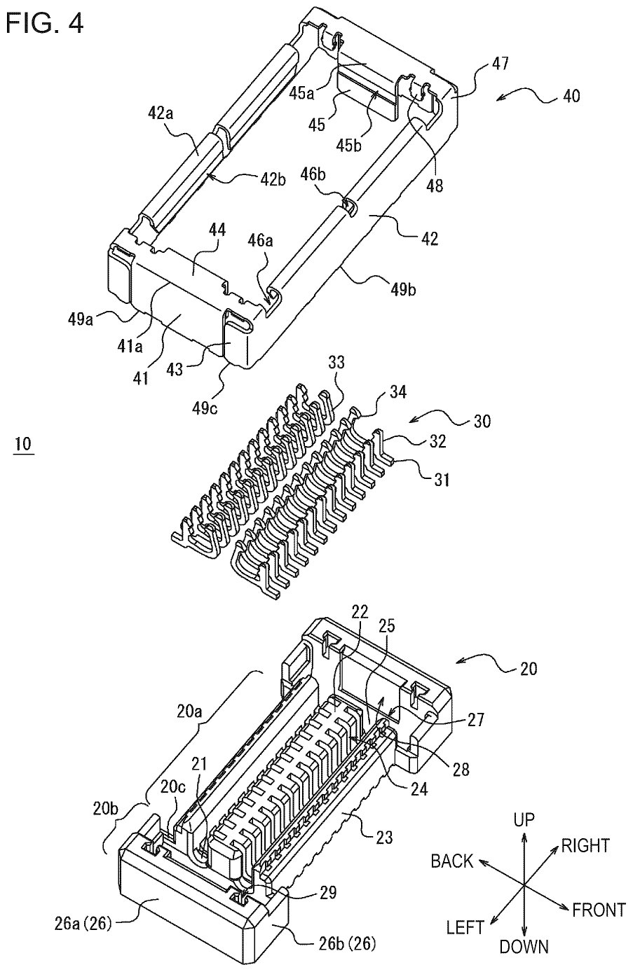

FIG. 3 is an external perspective view illustrating the first connector 10 in FIG. 1 alone in top view. FIG. 4 is an external perspective view illustrating the first connector 10 in FIG. 3 as exploded in top view. The first connector 10 is obtained by, as one example, press-fitting of the first contacts 30 to the first insulator 20 from below and press-fitting of the first shield member 40 to the first insulator 20 from above.

The first insulator 20 included in the first connector 10 is made of an insulating, heat-resistant synthetic resin material. The first insulator 20 extends in a plate-like shape in the left-right direction. The first insulator 20 includes a first portion 20a to which the first contacts 30 are attached. The first insulator 20 includes a second portion 20b positioned on each outer side of the first portion 20a in the second direction and to which the first shield member 40 is attached. The first insulator 20 includes coupling parts 20c extending in the first direction and coupling the first portion 20a to the second portion 20b. The coupling parts 20c slightly project upward with respect to a second bottom wall 25 described later. The coupling parts 20c extend to both outer sides in the first direction from an end part of the first portion 20a in the second direction. The second portion 20b symmetrically projects to both sides in the first direction with respect to the first portion 20a and is wider than the first portion 20a in the first direction.

The first portion 20a of the first insulator 20 includes a first bottom wall 21 forming a lower part. The first portion 20a of the first insulator 20 includes a fit protrusion 22 projecting upward from a center part in the front-back and left-right directions of the first bottom wall 21. The first portion 20a of the first insulator 20 includes longitudinal walls 23 extending in the left-right direction on both sides of the fit protrusion 22 in the front-back direction. The longitudinal walls 23 are positioned at an outer periphery of the first portion 20a of the first insulator 20. The longitudinal walls 23 surround the fit protrusion 22 from both sides in the front-back direction.

The first portion 20a of the first insulator 20 includes first contact attachment grooves 24 disposed across the inside of the longitudinal wall 23, the first bottom wall 21, and an inner surface in the front-back direction of the fit protrusion 22. The first contacts 30 are attached to the first contact attachment grooves 24. The first contact attachment grooves 24 include a plurality of first contact attachment grooves 24 corresponding to the number of first contacts 30. The plurality of first contact attachment grooves 24 is arranged in the arrangement direction of the plurality of first contacts 30.

The second portion 20b of the first insulator 20 includes the second bottom wall 25 forming a lower part. The second portion 20b of the first insulator 20 includes an outer peripheral wall 26 projecting upward from an outer-peripheral edge part of the second bottom wall 25. The outer peripheral wall 26 includes a transverse wall 26a extending in the first direction and outer walls 26b extending in the second direction and coupled to the longitudinal walls 23 by the coupling parts 20c. The outer peripheral wall 26 is positioned at an outer periphery of the second portion 20b of the first insulator 20.

The second portion 20b of the first insulator 20 includes a first groove part 27 recessed from a surface of the second bottom wall 25 toward the side opposite to the second connector 50 side, that is, downwardly. The second portion 20b of the first insulator 20 includes a recess 28 disposed continuously with the first groove part 27 at an inner surface in the left-right direction of the transverse wall 26a. The recess 28 is disposed with a front-back width identical to that of the first groove part 27 across the aforementioned inner surface entirely in the up-down direction. The second portion 20b of the first insulator 20 includes attachment grooves 29 recessed at both sides in the front-back direction of the transverse wall 26a.

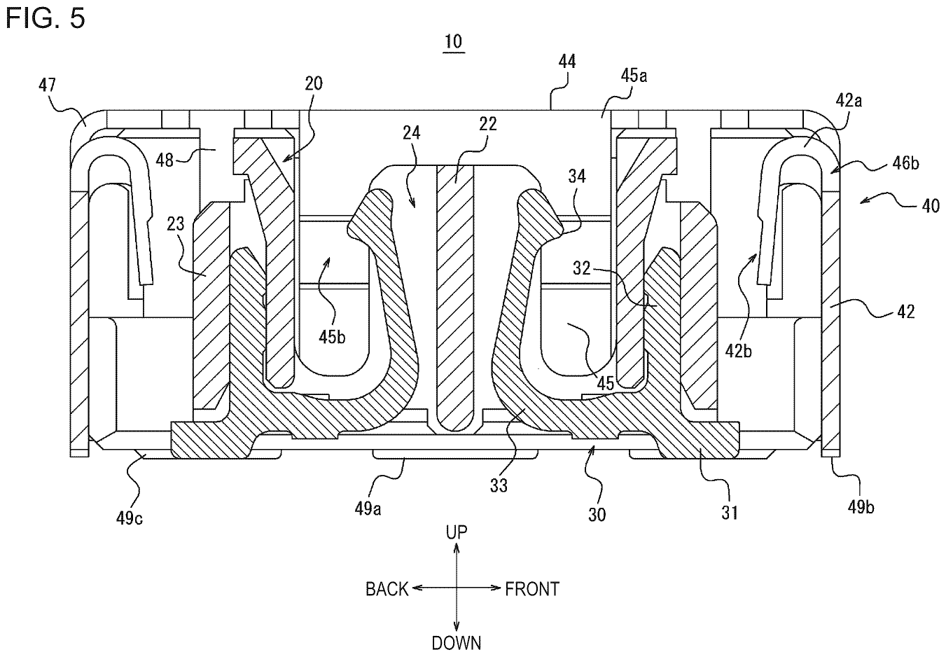

FIG. 5 is a sectional view taken along arrow line V-V in FIG. 3. A configuration of the first contacts 30 is described with reference mainly to FIGS. 4 and 5.

For example, the first contacts 30 have spring elasticity and are made through forming of a thin plate of a copper alloy, including phosphor bronze, beryllium copper, or titanium copper, or a Corson copper alloy into a shape illustrated in FIGS. 4 and 5 by using a progressive die (stamping). Surfaces of the first contacts 30 are plated with gold, tin, or the like after formation of an underlying layer by nickel plating.

Each first contact 30 includes a mount part 31 linearly extending outward in the front-back direction. The first contact 30 includes an engagement part 32 linearly extending upward from an inner-end part in the front-back direction of the mount part 31. The engagement part 32 has a wider width in the front-back direction. The first contact 30 includes an elastic contact piece 33 projecting in a J-shape inwardly in the front-back direction from a coupling portion between the mount part 31 and the engagement part 32. The first contact 30 includes a contact part 34 positioned at a tip end of the elastic contact piece 33 and projecting outward in the front-back direction.

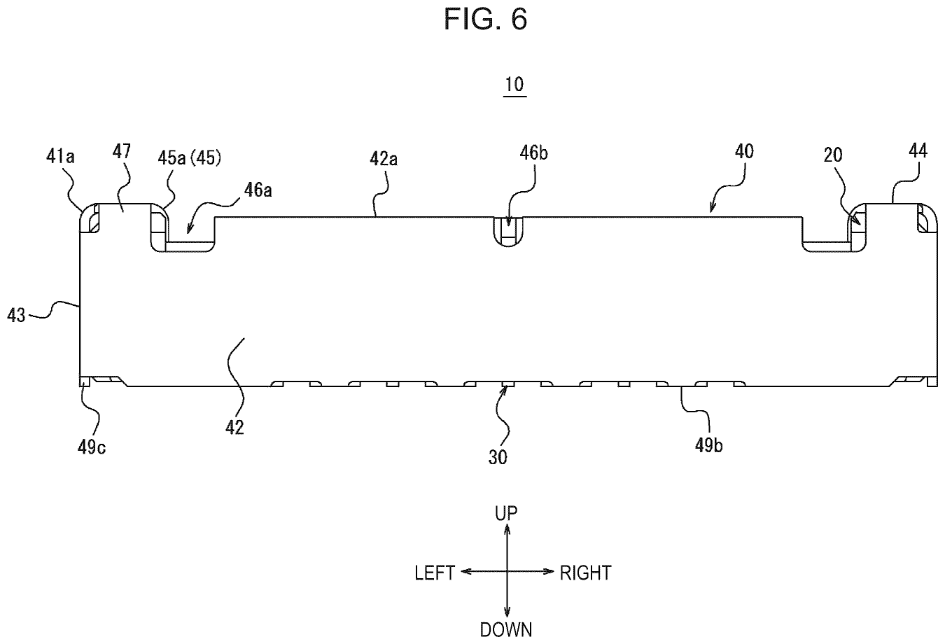

FIG. 6 is a front view of the first connector 10 in FIG. 3. A configuration of the first shield member 40 is described with reference mainly to FIGS. 4 and 6.

The first shield member 40 is made through forming of a thin plate of any metal material into a shape illustrated in FIGS. 4 and 6 by using a progressive die (stamping). The method for processing the first shield member 40 includes a step of bending the thin plate in the plate-thickness direction after punching the thin plate. The method for processing the first shield member 40 is not limited to this, and the first shield member 40 may be processed through a step including drawing. The first shield member 40 is made of a single metal plate.

The first shield member 40 includes a pair of first side walls 41 extending in the first direction. The first shield member 40 includes a pair of second side walls 42 extending in the second direction intersecting with the first direction. The first shield member 40 includes a folded part 43 folded from each of the second side walls 42 toward a corresponding one of the first side walls 41. A fracture surface of the folded part 43 and a fracture surface of the corresponding one of the first side walls 41 are opposed to one another without the first insulator 20 interposed therebetween. The first side wall 41, the folded part 43, and the second side wall 42 are positioned at an outer periphery of the first shield member 40 and the first connector 10. The first shield member 40 covers the outer periphery except for a portion where a slight gap is positioned between the fracture surface of the folded part 43 and the fracture surface of the first side wall 41.

The first shield member 40 includes a first end-surface part 44 including a surface extending along each of the pair of first side walls 41 and facing toward the second connector 50 side when the first connector 10 and the second connector 50 are fitted together while being opposed to one another. The first end-surface part 44 includes an upper surface of the first shield member 40.

The first side wall 41 is disposed continuously with the first end-surface part 44. More specifically, the first side wall 41 extends in the third direction intersecting with the first direction and the second direction from the first end-surface part 44 at the outer side in the second direction. The first side wall 41 extends to bend downwardly from an edge part of the first end-surface part 44 at the outer side in the left-right direction. The first side wall 41 includes a first curved-surface part 41a connected to the first end-surface part 44 and having a rounded shape.

The first shield member 40 includes a first extension part 45 extending in the third direction from the first end-surface part 44 at the inner side in the second direction. The first extension part 45 extends to bend downwardly from an edge part of the first end-surface part 44 at the inner side in the left-right direction. The first extension part 45 includes a second curved-surface part 45a connected to the first end-surface part 44 and having a rounded shape. The first extension part 45 includes a first recess 45b disposed at an inner surface in the left-right direction of the first extension part 45.

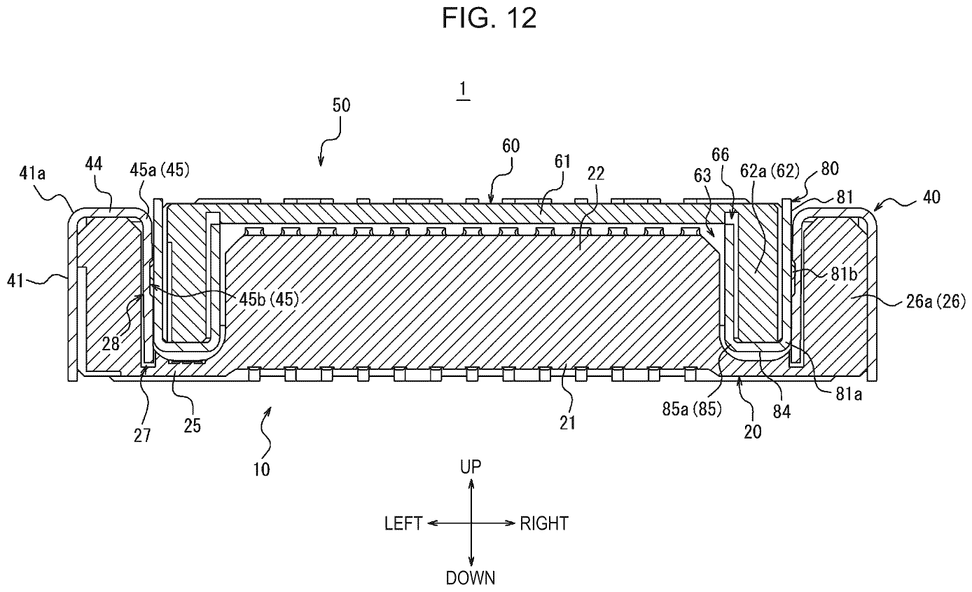

The first side wall 41, the first end-surface part 44, and the first extension part 45 form, as is also illustrated in FIG. 12 described later, an inverted U shape in sectional view in the front-back direction. The first side wall 41, the first end-surface part 44, and the first extension part 45 are disposed continuously. The first side wall 41 is disposed smoothly continuously with the first end-surface part 44 with the first curved-surface part 41a interposed therebetween. The first extension part 45 is disposed smoothly continuously with the first end-surface part 44 with the second curved-surface part 45a interposed therebetween.

The second side wall 42 includes, as is also illustrated in FIG. 5, elastic contact pieces 42a extending inwardly in the front-back direction in an inverted U shape at an upper edge part of the second side wall 42 and then extending obliquely downwardly to the inner side. The elastic contact pieces 42a each include a second recess 42b disposed at an inner surface in the front-back direction of the elastic contact piece 42a. A pair of elastic contact pieces 42a separated from one another in the left-right direction is disposed at the second side wall 42.

The first shield member 40 includes a plurality of cutout parts 46a formed by cutting a second connector 50 side portion, that is, a first end part at the upper side, of the second side wall 42 toward the side opposite to the second connector 50 side. The cutout parts 46a are disposed at both outer sides in the left-right direction with respect to the pair of elastic contact pieces 42a. The first shield member 40 includes a cutout part 46b disposed between the pair of elastic contact pieces 42a.

The first shield member 40 includes third curved-surface parts 47 each continuously connecting the first end-surface part 44 to the second side wall 42 and having a rounded shape. The second side wall 42 is disposed continuously with the first end-surface part 44. More specifically, the second side wall 42 extends in the third direction from the first end-surface part 44 at the outer side in the first direction with the third curved-surface part 47 interposed therebetween. The second side wall 42 extends downwardly from the third curved-surface part 47 bending at an edge part of the first end-surface part 44 at the outer side in the front-back direction.

The first shield member 40 includes engagement parts 48 extending in the third direction from the first end-surface part 44 at the inner side in the second direction. The engagement parts 48 extend to bend downwardly from the edge part of the first end-surface part 44 at the inner side in the left-right direction.

The first shield member 40 includes a first mount part 49a linearly extending downward from a lower edge part of the first side wall 41. The first shield member 40 includes a second mount part 49b linearly extending downward from a lower edge part of the second side wall 42. The first shield member 40 includes a third mount part 49c linearly extending downward from a lower edge part of the folded part 43.

As illustrated in FIG. 6, the first end-surface part 44 is positioned at the second connector 50 side with respect to the first end part at the second connector 50 side of the second side wall 42 while the first connector 10 and the second connector 50 are opposed to one another when fitted together. The first end-surface part 44 is positioned at the upper side with respect to an upper-end part of the second side wall 42, more specifically, top parts of the inverted U-shaped portions of the elastic contact pieces 42a. A surface of the first end-surface part 44 facing upward is positioned topmost among all the components of the first shield member 40. The surface of the first end-surface part 44 facing upward is positioned furthest toward the second connector 50 side in the first shield member 40 when the first connector 10 and the second connector 50 are fitted together while being opposed to one another.

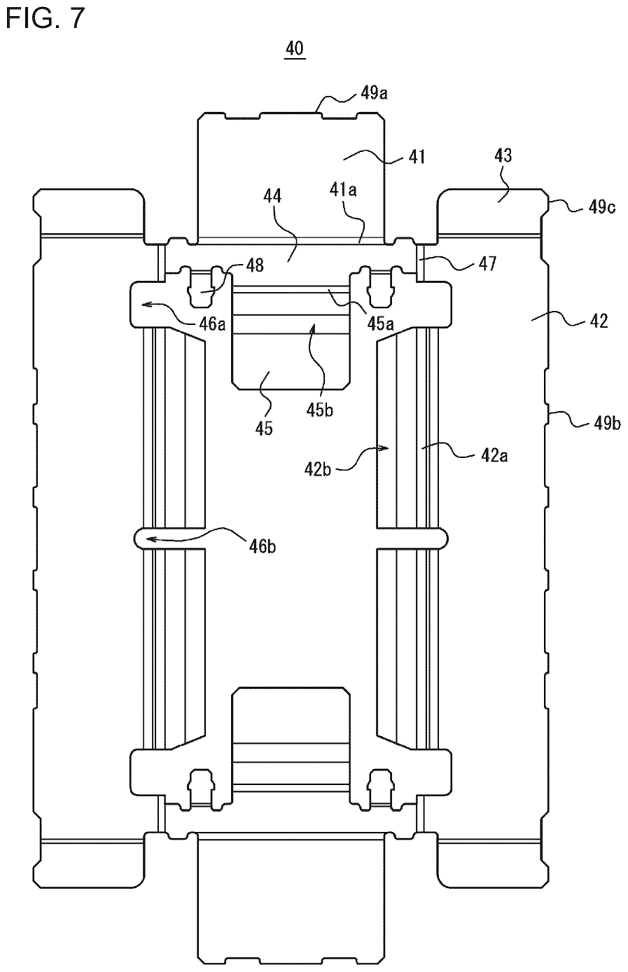

FIG. 7 is a developed view illustrating the first shield member 40 in FIG. 4 before bending in a plate-thickness direction. With regard to the first shield member 40 bent in the plate-thickness direction as illustrated in FIG. 4, a length of the engagement parts 48 in the third direction is shorter than a length of the cutout parts 46a in the second direction. In the developed view illustrated in FIG. 7, a projecting amount of the engagement parts 48 of the first shield member 40 is smaller than width of the cutout parts 46a. Tip ends of the engagement parts 48 in the projecting direction are positioned within the width of the cutout parts 46a and do not interfere with the elastic contact pieces 42a that are opposed to the engagement parts 48.

As illustrated in FIG. 5, the first contacts 30 are press-fitted from below the first insulator 20. At this time, the engagement parts 32 engage with portions of the first contact attachment grooves 24 that are disposed inside the longitudinal wall 23. Therefore, the first contacts 30 are held with respect to the first contact attachment grooves 24. The first contacts 30 are attached to the first portion 20a of the first insulator 20.

When the first contact attachment grooves 24 of the first insulator 20 hold the first contacts 30, the contact parts 34 of the elastic contact pieces 33 are exposed from the first contact attachment grooves 24 between the fit protrusion 22 and the longitudinal wall 23. At this time, the elastic contact pieces 33 are elastically deformable in the front-back direction inside the first contact attachment grooves 24. Tip ends of the mount parts 31 in the front-back direction are positioned at the second side wall 42 side of the first shield member 40 with respect to the longitudinal wall 23.

As will be appreciated from FIGS. 3 and 4, the first shield member 40 is press-fitted from above the first insulator 20. At this time, the engagement parts 48 engage with the attachment grooves 29 of the second portion 20b of the first insulator 20. Therefore, the first shield member 40 is held with respect to the attachment grooves 29. The first shield member 40 is attached to the second portion 20b of the first insulator 20.

When the attachment grooves 29 of the first insulator 20 hold the first shield member 40, the first side wall 41 is disposed along an outer surface in the left-right direction of the transverse wall 26a of the first insulator 20 and covers a part of the aforementioned outer surface from the outer side in the left-right direction. The first curved-surface part 41a is disposed along a connecting portion between the aforementioned outer surface and an upper surface of the transverse wall 26a and covers a part of the connecting portion from outside of the first insulator 20. The second side wall 42 is disposed along an outer surface in the front-back direction of the transverse wall 26a, an outer surface in the front-back direction of the outer wall 26b, and an outer surface in the front-back direction of the longitudinal wall 23 of the first insulator 20 and covers these outer surfaces from the outer side in the front-back direction.

The second side wall 42 and the longitudinal wall 23 are largely separated from one another in the front-back direction. The elastic contact pieces 42a of the second side wall 42 are positioned inside a space between the second side wall 42 and the longitudinal wall 23, and are elastically deformable in the front-back direction inside the space. The second recesses 42b of the second side wall 42 are opposed to the outer surface in the front-back direction of the longitudinal wall 23.

The folded part 43 is disposed along the outer surface in the left-right direction of the transverse wall 26a of the first insulator 20, and a connecting portion between the aforementioned outer surface and the outer surface in the front-back direction of the transverse wall 26a and covers a part of the outer surface and the connecting portion from outside of first insulator 20. The first end-surface part 44 is disposed along the upper surface of the transverse wall 26a of the first insulator 20 and covers substantially the entire upper surface from above. The first end-surface part 44 is parallel to the second bottom wall 25. An upper surface of the first end-surface part 44 is parallel to an upper surface of the second bottom wall 25.

The first extension part 45 is disposed at the recess 28 of the first insulator 20 and covers the recess 28 from the inner side in the left-right direction. At this time, as is also illustrated in FIG. 12 described later, an edge part of the first extension part 45 at a tip end in the third direction is accommodated in the first groove part 27. The first side wall 41, the first end-surface part 44, and the first extension part 45 continuously cover a part of the transverse wall 26a from both left and right sides and from above. The third curved-surface part 47 is disposed along a connecting portion between the upper surface of the transverse wall 26a and the outer surface in the front-back direction of the transverse wall 26a and covers a part of the connecting portion from outside of the first insulator 20.

As described above, the first shield member 40 is disposed on the outer side in the front-back and left-right directions of the first insulator 20 as a whole and covers substantially the entire first insulator 20 from the front-back and left-right directions. The entire first shield member 40, except for a portion thereof where a slight gap is positioned between the fracture surface of the folded part 43 and the fracture surface of the first side wall 41, covers the first insulator 20 from the outer side in the front-back and left-right directions. In addition, the first shield member 40 covers, from above, a part of the outer peripheral wall 26 of the first insulator 20.

The first mount part 49a is disposed along the outer surface in the left-right direction of the transverse wall 26a. The first mount part 49a extends downwardly further than a lower-end part of the transverse wall 26a. The second mount part 49b is disposed along the outer surface in the front-back direction of the outer wall 26b and the outer surface in the front-back direction of the longitudinal wall 23. The second mount part 49b extends downwardly further than a lower-end part of the outer wall 26b and a lower-end part of the longitudinal wall 23. The third mount part 49c is disposed along the outer surface in the left-right direction of the transverse wall 26a. The third mount part 49c extends downwardly further than the lower-end part of the transverse wall 26a.

The surface of the first end-surface part 44 facing upward is positioned at the second connector 50 side with respect to upper-end surfaces of the first contacts 30 when the first connector 10 and the second connector 50 are fitted together while being opposed to one another. The upper surface of the first shield member 40 attached to the first insulator 20 is positioned at the upper side with respect to upper surfaces of the first contacts 30 attached to the first insulator 20. The first end-surface part 44 is positioned furthest toward the second connector 50 side in the first connector 10 when the first connector 10 and the second connector 50 are fitted together while being opposed to one another.

In the first connector 10 with the structure as described above, as illustrated in FIG. 3, the mount parts 31 of the first contacts 30 are soldered to a circuit pattern disposed at a mount surface of the circuit board CB1. The first mount part 49a, the second mount part 49b, and the third mount part 49c of the first shield member 40 are soldered to a circuit pattern disposed at the mount surface. In this manner, each mount part is mounted on the circuit board CB1, so that the first connector 10 is mounted on the circuit board CB1. On the mount surface of the circuit board CB1, electronic components other than the first connector 10, for example, a central processing unit (CPU), a controller, and a memory are mounted.

A configuration of the second connector 50 is described with reference mainly to FIGS. 8 to 10.

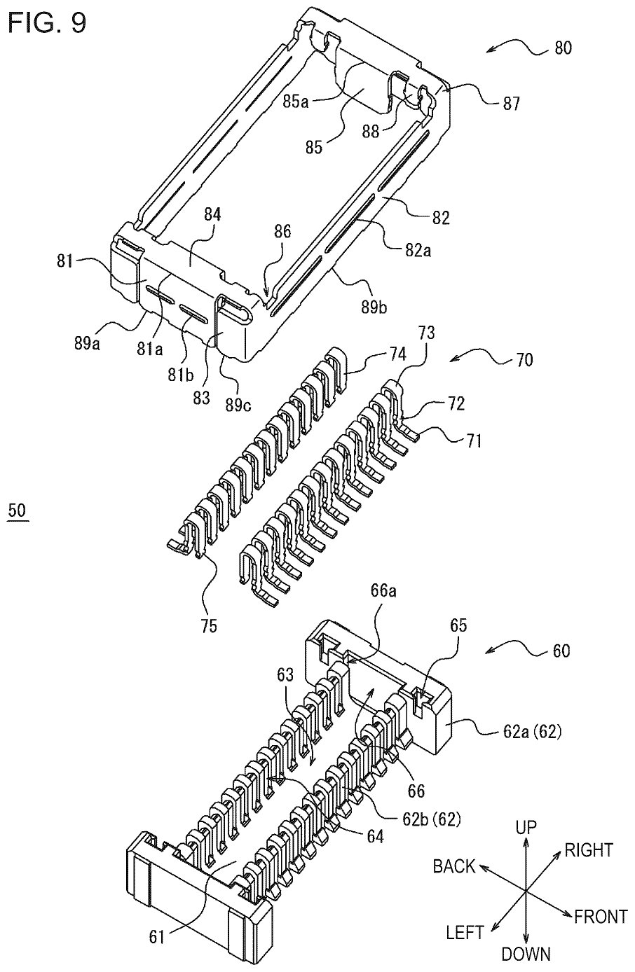

FIG. 8 is an external perspective view illustrating the second connector 50 in FIG. 1 alone in top view. FIG. 9 is an external perspective view illustrating the second connector 50 in FIG. 8 as exploded in top view. The second connector 50 is obtained by, as one example, press-fitting of the second contacts 70 and the second shield member 80 to the second insulator 60 from above.

The second insulator 60 is a plate-like member formed by injection molding of an insulating, heat-resistant synthetic resin material, and extending in the left-right direction. The second insulator 60 includes a bottom plate part 61 forming a lower part. The second insulator 60 includes an annular outer peripheral wall 62 projecting upward along an outer periphery in the front-back and left-right directions of the bottom plate part 61. The outer peripheral wall 62 extends in the first direction and the second direction. The outer peripheral wall 62 includes a transverse wall 62a and a longitudinal wall 62b. The transverse wall 62a extends in the first direction and is wider in the front-back direction than a gap between a pair of longitudinal walls 62b in the front-back direction. The longitudinal wall 62b extends in the second direction. The second insulator 60 includes a fit recess 63 surrounded by the outer peripheral wall 62 from the four directions of the front-back and left-right directions.

The second insulator 60 includes second contact attachment grooves 64 disposed at the longitudinal wall 62b. The second contacts 70 are attached to the second contact attachment grooves 64. The second contact attachment grooves 64 include a plurality of second contact attachment grooves 64 corresponding to the number of second contacts 70. The plurality of second contact attachment grooves 64 is arranged in the arrangement direction of the plurality of second contacts 70.

The second insulator 60 includes attachment grooves 65 recessed at both sides in the front-back direction of the transverse wall 62a. The second shield member 80 is attached to the attachment grooves 65. The second insulator 60 includes a recess 66 disposed at an inner surface in the left-right direction of the transverse wall 62a. The recess 66 is disposed across the inner surface entirely in the up-down direction. The recess 66 includes a second groove part 66a recessed in the third direction at the outer peripheral wall 62.

The second groove part 66a is recessed in the third direction at the transverse wall 62a and includes a space surrounded by the transverse wall 62a and the longitudinal wall 62b. The second groove part 66a is disposed at the recess 66 and is surrounded by the transverse wall 62a and the longitudinal wall 62b. The second groove part 66a is surrounded from three directions by the inner surface in the left-right direction of the transverse wall 62a, that is, a surface of the recess 66 in the left-right direction, an inner surface in the front-back direction of the transverse wall 62a, that is, a surface of the recess 66 in the front-back direction, and an end surface in the left-right direction of the longitudinal wall 62b.

A configuration of the second contacts 70 is described with reference mainly to FIG. 9.

For example, the second contacts 70 are made through forming of a thin plate of a copper alloy, including phosphor bronze, beryllium copper, or titanium copper, or a Corson copper alloy into a shape illustrated in FIG. 9 by using a progressive die (stamping). Surfaces of the second contacts 70 are plated with gold, tin, or the like after formation of an underlying layer by nickel plating.

Each second contact 70 includes a mount part 71 linearly extending outward in the front-back direction. The second contact 70 includes a first engagement part 72 extending upward from the mount part 71 and having a wider width in the left-right direction. The second contact 70 includes a folded part 73 extending upward from an upper end of the first engagement part 72 and folded in an inverted U shape.

The second contact 70 includes a contact part 74 disposed at the folded part 73. The contact part 74 includes an inner surface of the folded part 73 facing inward in the front-back direction of the second connector 50. The second contact 70 includes a second engagement part 75 at a tip end of the folded part 73. The second engagement part 75 is positioned directly below the contact part 74 of the folded part 73.

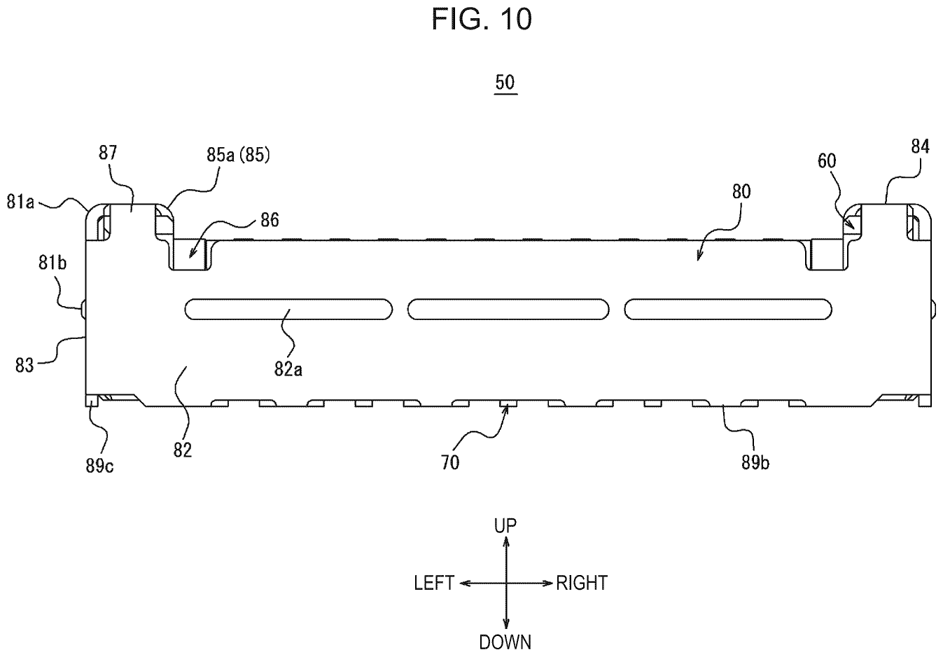

FIG. 10 is a front view of the second connector 50 in FIG. 8. A configuration of the second shield member 80 is described with reference mainly to FIGS. 9 and 10.

The second shield member 80 is made through forming of a thin plate of any metal material into a shape illustrated in FIGS. 9 and 10 by using a progressive die (stamping). The method for processing the second shield member 80 includes a step of bending the thin plate in the plate-thickness direction after punching the thin plate. The method for processing the second shield member 80 is not limited to this, and the second shield member 80 may be processed through a step including drawing. The second shield member 80 is made of a single metal plate.

The second shield member 80 includes a pair of third side walls 81 extending in the first direction. The second shield member 80 includes a pair of fourth side walls 82 extending in the second direction intersecting with the first direction. The second shield member 80 includes a folded part 83 folded from each of the fourth side walls 82 toward a corresponding one of the third side walls 81. A fracture surface of the folded part 83 and a fracture surface of the corresponding one of the third side walls 81 are opposed to one another without the second insulator 60 interposed therebetween. The third side wall 81, the folded part 83, and the fourth side wall 82 are positioned at an outer periphery of the second shield member 80 and the second connector 50. The second shield member 80 covers the outer periphery except for a portion where a slight gap is positioned between the fracture surface of the folded part 83 and the fracture surface of the third side wall 81.

The second shield member 80 includes a second end-surface part 84 including a surface extending along each of the pair of third side walls 81 and facing toward the first connector 10 side when the first connector 10 and the second connector 50 are fitted together while being opposed to one another. The second end-surface part 84 includes an upper surface of the second shield member 80.

The third side wall 81 is disposed continuously with the second end-surface part 84. More specifically, the third side wall 81 extends in the third direction intersecting with the first direction and the second direction from the second end-surface part 84 at the outer side in the second direction. The third side wall 81 extends to bend downwardly from an edge part of the second end-surface part 84 at the outer side in the left-right direction. The third side wall 81 includes a first curved-surface part 81a connected to the second end-surface part 84 and having a rounded shape.

The second shield member 80 includes a second extension part 85 extending in the third direction from the second end-surface part 84 at the inner side in the second direction. The second extension part 85 extends to bend downwardly from an edge part of the second end-surface part 84 at the inner side in the left-right direction. The second extension part 85 includes a second curved-surface part 85a connected to the second end-surface part 84 and having a rounded shape.

The third side wall 81, the second end-surface part 84, and the second extension part 85 form, as is also illustrated in FIG. 12 described later, an inverted U shape in sectional view in the front-back direction. The third side wall 81, the second end-surface part 84, and the second extension part 85 are disposed continuously. The third side wall 81 is disposed smoothly continuously with the second end-surface part 84 with the first curved-surface part 81a interposed therebetween. The second extension part 85 is disposed smoothly continuously with the second end-surface part 84 with the second curved-surface part 85a interposed therebetween.

The third side wall 81 includes first protrusions 81b projecting outward in the left-right direction from an outer surface in the left-right direction of the third side wall 81. The fourth side wall 82 includes second protrusions 82a projecting outward in the front-back direction from an outer surface in the front-back direction of the fourth side wall 82.

The second shield member 80 includes a plurality of cutout parts 86 formed by cutting a first connector 10 side portion, that is, a second end part at the upper side, of the fourth side wall 82 toward the side opposite to the first connector 10 side. A pair of cutout parts 86 are disposed at respective ones of both left and right sides of the fourth side wall 82.

The second shield member 80 includes third curved-surface parts 87 each continuously connecting the second end-surface part 84 to the fourth side wall 82 and having a rounded shape. The fourth side wall 82 is disposed continuously with the second end-surface part 84. More specifically, the fourth side wall 82 extends in the third direction from the second end-surface part 84 at the outer side in the first direction with the third curved-surface part 87 interposed therebetween. The fourth side wall 82 extends downwardly from the third curved-surface part 87 bending at an edge part of the second end-surface part 84 at the outer side in the front-back direction.

The second shield member 80 includes engagement parts 88 extending in the third direction from the second end-surface part 84 at the inner side in the second direction. The engagement parts 88 extend to bend downwardly from the edge part of the second end-surface part 84 at the inner side in the left-right direction.

The second shield member 80 includes a first mount part 89a linearly extending downward from a lower edge part of the third side wall 81. The second shield member 80 includes a second mount part 89b linearly extending downward from a lower edge part of the fourth side wall 82. The second shield member 80 includes a third mount part 89c linearly extending downward from a lower edge part of the folded part 83.

As illustrated in FIG. 10, the second end-surface part 84 is positioned at the first connector 10 side with respect to the second end part at the first connector 10 side of the fourth side wall 82 while the first connector 10 and the second connector 50 are opposed to one another when fitted together. The second end-surface part 84 is positioned at the upper side with respect to an upper-end part of the fourth side wall 82. A surface of the second end-surface part 84 facing upward is positioned topmost among all the components of the second shield member 80. The surface of the second end-surface part 84 facing upward is positioned furthest toward the first connector 10 side in the second shield member 80 when the first connector 10 and the second connector 50 are fitted together while being opposed to one another.

As will be appreciated from FIGS. 8 and 9, the second contacts 70 are press-fitted from above the second insulator 60. At this time, the first engagement parts 72 and the second engagement parts 75 engage with the second contact attachment grooves 64. Therefore, the second contacts 70 are held with respect to the second contact attachment grooves 64. The second contacts 70 are attached to the longitudinal wall 62b of the second insulator 60.

When the second contact attachment grooves 64 of the second insulator 60 hold the second contacts 70, the contact parts 74 are disposed to face the inner side of the fit recess 63. Tip ends of the mount parts 71 in the front-back direction are positioned between the longitudinal wall 62b and the fourth side wall 82 of the second shield member 80.

As will be appreciated from FIGS. 8 and 9, the second shield member 80 is press-fitted from above the second insulator 60. At this time, the engagement parts 88 engage with the attachment grooves 65 of the second insulator 60. Therefore, the second shield member 80 is held with respect to the attachment grooves 65. The second shield member 80 is attached to the transverse wall 62a of the second insulator 60.

When the attachment grooves 65 of the second insulator 60 hold the second shield member 80, the third side wall 81 is disposed along an outer surface in the left-right direction of the transverse wall 62a of the second insulator 60 and covers a part of the aforementioned outer surface from the outer side in the left-right direction. The first curved-surface part 81a is disposed along a connecting portion between the aforementioned outer surface and an upper surface of the transverse wall 62a and covers a part of the connecting portion from outside of the second insulator 60. The fourth side wall 82 is disposed along an outer surface in the front-back direction of the transverse wall 62a and an outer surface in the front-back direction of the longitudinal wall 62b of the second insulator 60 and covers these outer surfaces from the outer side in the front-back direction. The fourth side wall 82 and the longitudinal wall 62b are largely separated from one another in the front-back direction.

The folded part 83 is disposed along the outer surface in the left-right direction of the transverse wall 62a of the second insulator 60 and a connecting portion between the aforementioned outer surface and the outer surface in the front-back direction of the transverse wall 62a and covers a part of the aforementioned outer surface and the connecting portion from outside of the second insulator 60. The second end-surface part 84 is disposed along the upper surface of the transverse wall 62a of the second insulator 60 and covers substantially the entire upper surface from above. The second end-surface part 84 is parallel to the bottom plate part 61. An upper surface of the second end-surface part 84 is parallel to an upper surface of the bottom plate part 61.

The second extension part 85 is disposed at the recess 66 of the second insulator 60 and covers the recess 66 from the inner side in the left-right direction. At this time, an edge part of the second extension part 85 in the first direction is accommodated in the second groove part 66a. The edge part of the second extension part 85 in the first direction is disposed at the recess 66 and is surrounded by the transverse wall 62a and the longitudinal wall 62b. The edge part of the second extension part 85 in the first direction is surrounded from three directions by the inner surface in the left-right direction of the transverse wall 62a, that is, the surface of the recess 66 in the left-right direction, the inner surface in the front-back direction of the transverse wall 62a, that is, the surface of the recess 66 in the front-back direction, and the end surface in the left-right direction of the longitudinal wall 62b. The edge part of the second extension part 85 in the first direction is positioned between the end surface of the longitudinal wall 62b in the second direction and the inner surface of the transverse wall 62a in the second direction.

The third side wall 81, the second end-surface part 84, and the second extension part 85 continuously disposed cover a part of the transverse wall 62a from both left and right sides and from above. The third curved-surface part 87 is disposed along a connecting portion between the upper surface of the transverse wall 62a and the outer surface in the front-back direction of the transverse wall 62a and covers a part of the connecting portion from outside of the second insulator 60.

As described above, the second shield member 80 is disposed on the outer side in the front-back and left-right directions of the second insulator 60 as a whole and covers substantially the entire second insulator 60 from the front-back and left-right directions. The entire second shield member 80, except for a portion thereof where a slight gap is positioned between the fracture surface of the folded part 83 and the fracture surface of the third side wall 81, covers the second insulator 60 from the outer side in the front-back and left-right directions. In addition, the second shield member 80 covers, from above, substantially the entire transverse wall 62a of the second insulator 60.

The first mount part 89a is disposed along the outer surface in the left-right direction of the transverse wall 62a. The first mount part 89a extends downwardly further than a lower-end part of the transverse wall 62a. The second mount part 89b is disposed along the outer surface in the front-back direction of the longitudinal wall 62b. The second mount part 89b extends downwardly further than a lower-end part of the longitudinal wall 62b. The third mount part 89c is disposed along the outer surface in the left-right direction of the transverse wall 62a. The third mount part 89c extends downwardly further than the lower-end part of the transverse wall 62a.

The surface of the second end-surface part 84 facing upward is positioned at the first connector 10 side with respect to upper-end surfaces of the second contacts 70 when the first connector 10 and the second connector 50 are fitted together while being opposed to one another. The upper surface of the second shield member 80 attached to the second insulator 60 is positioned at the upper side with respect to upper surfaces of the second contacts 70 attached to the second insulator 60. The second end-surface part 84 is positioned furthest toward the first connector 10 side in the second connector 50 when the first connector 10 and the second connector 50 are fitted together while being opposed to one another.

In the second connector 50 with the structure as described above, as illustrated in FIG. 8, the mount parts 71 of the second contacts 70 are soldered to a circuit pattern disposed at a mount surface of the circuit board CB2. The first mount part 89a, the second mount part 89b, and the third mount part 89c of the second shield member 80 are soldered to a circuit pattern disposed at the mount surface. In this manner, each mount part is mounted on the circuit board CB2, so that the second connector 50 is mounted on the circuit board CB2. On the mount surface of the circuit board CB2, an electronic component other than the second connector 50, for example, a communication module is mounted.

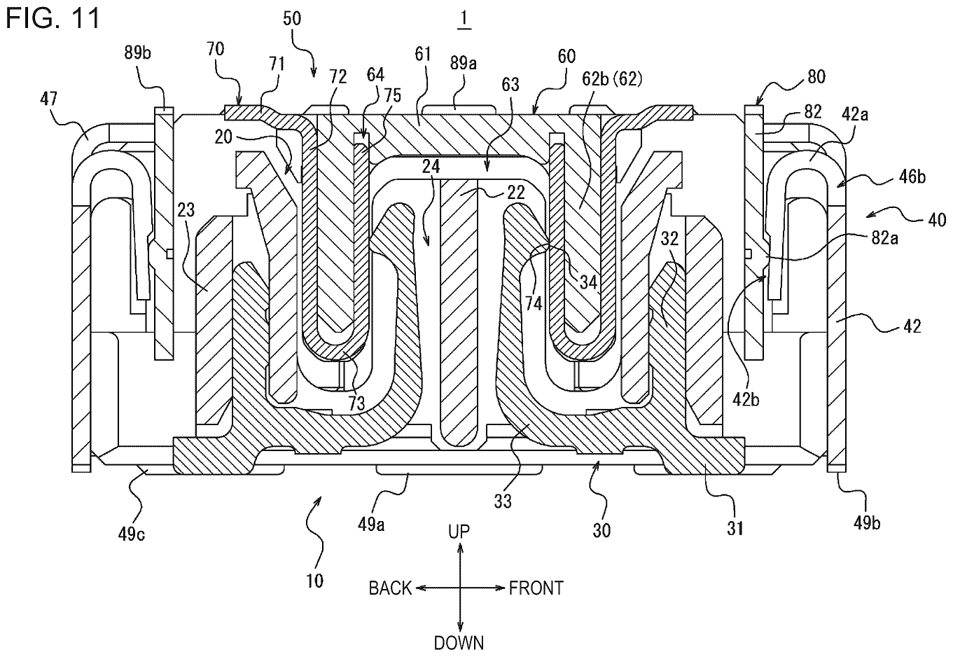

A configuration of the connector module 1 in the fitted state in which the first connector 10 and the second connector 50 are fitted to one another is described with reference mainly to FIGS. 11 and 12. FIG. 11 is a sectional view taken along arrow line XI-XI in FIG. 1.

In fitting of the connector module 1, the first connector 10 and the second connector 50 are opposed to one another. For example, the first connector 10 and the second connector 50 are opposed to one another in the up-down direction in such a manner that the front-back positions and the left-right positions are substantially consistent between the first connector 10 and the second connector 50 while the orientation in the up-down direction of the second connector 50 in FIG. 8 is upside down. The second connector 50 is moved downwardly.

Therefore, the first connector 10 and the second connector 50 are connected to one another to obtain a connected state of the connector module 1. At this time, the first insulator 20 is fitted to the second connector 50. The second insulator 60 is fitted to the first connector 10. The fit protrusion 22 of the first insulator 20 is fitted to the fit recess 63 of the second insulator 60.

In the fitted state, the elastic contact pieces 33 of the first contacts 30 are in contact with the folded parts 73 of the second contacts 70. In more detail, the contact parts 34 and the contact parts 74 are in contact with one another. At this time, the elastic contact pieces 33 with spring elasticity are elastically deformed inwardly in the front-back direction. The first contacts 30 and the second contacts 70 are each in contact with one another at one position between the contact part 34 and the contact part 74 at the fit protrusion 22 side.

In the fitted state, the first shield member 40 and the second shield member 80 are in contact with one another. For example, the elastic contact pieces 42a of the first shield member 40 and the fourth side wall 82 of the second shield member 80 are in contact with one another. More specifically, the second recesses 42b of the elastic contact pieces 42a engage with the second protrusions 82a of the fourth side wall 82 based on the protrusion and recess structure.

The elastic contact pieces 42a with spring elasticity are in contact with the second shield member 80 in the fitted state and are elastically deformed outwardly in the front-back direction. The first shield member 40 and the second shield member 80 are in contact with one another at a plurality of positions by the second recesses 42b and the second protrusions 82a at both sides in the front-back direction. The second shield member 80 receives biasing force applied inwardly in the front-back direction from the elastic contact pieces 42a elastically deformed outwardly in the front-back direction. Such biasing force provides contact pressure of the first shield member 40 on the second shield member 80.

FIG. 12 is a sectional view taken along arrow line XII-XII in FIG. 1.

In the fitted state, the transverse wall 62a of the second shield member 80 is disposed inside a space surrounded by the outer peripheral wall 26 at the second portion 20b of the first insulator 20. The coupling parts 20c of the first insulator 20 are positioned within the cutout parts 86 of the second shield member 80 in the fitted state. More specifically, the coupling parts 20c extending in the first direction and the cutout parts 86 extending in the second direction intersect with one another in such a manner that the cutout parts 86 overlap with the coupling parts 20c from above.

In the fitted state, the first shield member 40 and the second shield member 80 are in contact with one another. For example, the first extension part 45 of the first shield member 40 and the third side wall 81 of the second shield member 80 are in contact with one another. More specifically, the first recess 45b of the first extension part 45 engages with the first protrusions 81b of the third side wall 81 based on the protrusion and recess structure.

In an embodiment as described above, the connector module 1 can achieve a shield structure that facilitates fitting work between the first connector 10 and the second connector 50. In the connector module 1, the first end-surface part 44 is positioned at the second connector 50 side with respect to the first end part at the second connector 50 side of each of the pair of second side walls 42. The second end-surface part 84 is positioned at the first connector 10 side with respect to the second end part at the first connector 10 side of each of the pair of fourth side walls 82. Therefore, when the first connector 10 and the second connector 50 are fitted together while being opposed to one another, the first end-surface part 44 and the second end-surface part 84 disposed in a planar manner at positions closer to the respective opposite connectors play a first positioning role in fitting. Thus, fitting work becomes easier.

Continuous disposing of the first side wall 41 and the first end-surface part 44 provides a leading effect when the first connector 10 and the second connector 50 are fitted together while being opposed to one another. Even when a position of the second connector 50 with respect to the first connector 10 deviates from a correct fitting position during fitting, the second shield member 80 continuously contacts the first side wall 41, the first curved-surface part 41a, and the first end-surface part 44, and thus the second connector 50 is guided to the correct fitting position. Thus, faulty contact is less likely to occur between the first contacts 30 and the second contacts 70 due to fitting of the first connector 10 and the second connector 50 at an erroneous position. The connector module 1 can maintain contact reliability between the first contacts 30 and the second contacts 70.

The first side wall 41 extends in the third direction from the first end-surface part 44 at the outer side in the second direction, and the first extension part 45 extends in the third direction from the first end-surface part 44 at the inner side in the second direction, thus providing the leading effect described above. Even when a position of the second connector 50 with respect to the first connector 10 deviates from a correct fitting position during fitting, the second shield member 80 continuously contacts the first side wall 41, the first curved-surface part 41a, the first end-surface part 44, the second curved-surface part 45a, and the first extension part 45, and thus the second connector 50 is guided to the correct fitting position. Thus, faulty contact is less likely to occur between the first contacts 30 and the second contacts 70 due to fitting of the first connector 10 and the second connector 50 at an erroneous position. The connector module 1 can maintain contact reliability between the first contacts 30 and the second contacts 70.

By the connector module 1 including the second curved-surface part 45a connecting the first extension part 45 to the first end-surface part 44, the first extension part 45 and the first end-surface part 44 are smoothly connected to one another to achieve effects related to the aforementioned leading and guiding.

The edge part of the first extension part 45 at the tip end in the third direction is accommodated in the first groove part 27. Therefore, when the first connector 10 and the second connector 50 are fitted to one another, the first shield member 40 is less likely to be folded over regardless of application of force to the first shield member 40 in an unexpected direction. Thus, the connector module 1 has improved reliability as a product.

Continuous disposing of the third side wall 81 and the second end-surface part 84 provides a leading effect when the first connector 10 and the second connector 50 are fitted together while being opposed to one another. Even when a position of the first connector 10 with respect to the second connector 50 deviates from a correct fitting position during fitting, the first shield member 40 continuously contacts the second end-surface part 84, the first curved-surface part 81a, and the third side wall 81, and thus the first connector 10 is guided to the correct fitting position. Thus, faulty contact is less likely to occur between the first contacts 30 and the second contacts 70 due to fitting of the first connector 10 and the second connector 50 at an erroneous position. The connector module 1 can maintain contact reliability between the first contacts 30 and the second contacts 70.

The third side wall 81 extends in the third direction from the second end-surface part 84 at the outer side in the second direction, and the second extension part 85 extends in the third direction from the second end-surface part 84 at the inner side in the second direction, thus providing the leading effect described above. Even when a position of the first connector 10 with respect to the second connector 50 deviates from a correct fitting position during fitting, the first shield member 40 continuously contacts the second extension part 85, the second curved-surface part 85a, the second end-surface part 84, the first curved-surface part 81a, and the third side wall 81, and thus the first connector 10 is guided to the correct fitting position. Thus, faulty contact is less likely to occur between the first contacts 30 and the second contacts 70 due to fitting of the first connector 10 and the second connector 50 at an erroneous position. The connector module 1 can maintain contact reliability between the first contacts 30 and the second contacts 70.

By the connector module 1 including the second curved-surface part 85a connecting the second extension part 85 to the second end-surface part 84, the second extension part 85 and the second end-surface part 84 are smoothly connected to one another to achieve effects related to the aforementioned leading and guiding.

The edge part of the second extension part 85 in the first direction is accommodated in the second groove part 66a and is surrounded by the transverse wall 62a and the longitudinal wall 62b. Therefore, when the first connector 10 and the second connector 50 are fitted to one another, the second shield member 80 is less likely to be folded over regardless of application of force to the second shield member 80 in an unexpected direction. Thus, the connector module 1 has improved reliability as a product.

Continuous disposing of the second side wall 42 and the first end-surface part 44 and folding of the folded part 43 from the second side wall 42 toward the first side wall 41 allow the first shield member 40 to continuously cover a corner part of the first connector 10 in an integral manner. Therefore, a shielding property against electromagnetic noise improves.

The fracture surface of the folded part 43 and the fracture surface of the first side wall 41 are opposed to one another without the first insulator 20 interposed therebetween. Thus, as compared to a known connector in which an engagement part of an insulator is interposed between these fracture surfaces and is not covered by a shield member, the first shield member 40 can cover a wider range around the first insulator 20. Therefore, a shielding property against electromagnetic noise improves.

The first shield member 40 includes the plurality of cutout parts 46a. Therefore, the second side wall 42 can include the elastic contact pieces 42a disposed as elastically deformable springs that bend inwardly in the front-back direction.

The length of the engagement parts 88 in the third direction is shorter than the length of the cutout parts 46a in the second direction, and thus the first shield member 40 can be made of a single metal plate. More specifically, as illustrated in FIG. 7, before bending of the first shield member 40 in the plate-thickness direction, the engagement parts 88 do not interfere with the elastic contact pieces 42a provided by the cutout parts 46a, and the respective components of the first shield member 40 can be provided by a single metal plate.

By the first insulator 20 including the coupling parts 20c coupling the first portion 20a to the second portion 20b, the first insulator 20 has improved strength. Therefore, the first connector 10 and the connector module 1 have improved robustness.

The coupling parts 20c are positioned within the cutout parts 86 in the fitted state. Therefore, the second connector 50 can be more deeply fitted to the first connector 10, and the connector module 1 in the connected state can have reduced height as a whole.

The first direction is the transverse direction of the connector module 1. The second direction is the longitudinal direction of the connector module 1. Therefore, the first end-surface part 44 is disposed at the transverse wall 26a side. The second end-surface part 84 is disposed at the transverse wall 62a side. Therefore, when the first connector 10 and the second connector 50 are fitted together while being opposed to one another, the first end-surface part 44 and the second end-surface part 84 first play a positioning role in the arrangement direction of the contacts including the first contacts 30 and the second contacts 70. Thus, fitting work becomes easier, and the contacts have reduced positional deviation therebetween in the contact arrangement direction. The connector module 1 can maintain contact reliability between the first contacts 30 and the second contacts 70.

As is obvious for a person skilled in the art, the present disclosure can be implemented in predetermined embodiments other than the embodiment described above without departing from the spirit or nature thereof. Accordingly, the foregoing description is exemplary, and the present disclosure is not limited to this. The scope of the disclosure is defined not by the foregoing description but by the appended claims. Among all variations, some of the variations within the range of equivalents are included in the scope of the disclosure.

For example, the shape, the size, the disposition, the orientation, and the number of each component described above are not limited to those in the foregoing descriptions and the illustration in the drawings. The shape, the size, the disposition, the orientation, and the number of each component may be configured in any way as long as the function thereof can be realized.

The method for assembling the first connector 10 and the second connector 50 described above is not limited to that in the foregoing description. The method for assembling the first connector 10 and the second connector 50 may be any method as long as the first connector 10 and the second connector 50 can be assembled to provide their respective functions. For example, in the first connector 10, at least one of the first contacts 30 or the first shield member 40 may be formed integrally with the first insulator 20 not through press-fitting but through insert molding. For example, in the second connector 50, at least one of the second contacts 70 or the second shield member 80 may be formed integrally with the second insulator 60 not through press-fitting but through insert molding.

In the description of the foregoing embodiment, the first side wall 41 is disposed continuously with the first end-surface part 44, but is not limited thereto. The first side wall 41 may not be disposed continuously with the first end-surface part 44. For example, the first shield member 40 may not include the first curved-surface part 41a.

In the description of the foregoing embodiment, the first side wall 41 extends in the third direction from the first end-surface part 44 at the outer side in the second direction, but is not limited thereto. The first side wall 41 may extend in the third direction from the first end-surface part 44 at the inner side in the second direction.

In the description of the foregoing embodiment, the first shield member 40 includes the first extension part 45 extending in the third direction from the first end-surface part 44 at the inner side in the second direction, but is not limited thereto. The first shield member 40 may not include such a first extension part 45.

In the description of the foregoing embodiment, the first side wall 41 and the first extension part 45 extend from the first end-surface part 44 at the outer side in the second direction and at the inner side in the second direction, respectively, but are not limited thereto. At least one of the first side wall 41 or the first extension part 45 may not be disposed continuously with the first end-surface part 44. For example, the first shield member 40 may not include the second curved-surface part 45a.

In the description of the foregoing embodiment, the first extension part 45 includes the second curved-surface part 45a connected to the first end-surface part 44 and having a rounded shape, but is not limited thereto. The second curved-surface part 45a may be formed based on another curved surface different from the rounded shape. The first extension part 45 and the first end-surface part 44 may be connected to one another with an inclined surface instead of the curved surface.

In the description of the foregoing embodiment, the first insulator 20 includes the first groove part 27 recessed toward the side opposite to the second connector 50 side from the surface of the second bottom wall 25, but is not limited thereto. The first insulator 20 may not include such a first groove part 27.

In the description of the foregoing embodiment, the edge part of the first extension part 45 at the tip end in the third direction is accommodated in the first groove part 27, but is not limited thereto. The edge part of the first extension part 45 at the tip end in the third direction may not be accommodated in the first groove part 27 while the first groove part 27 is disposed at the first insulator 20. The edge part may simply be positioned in the recess 28 while the first groove part 27 is not disposed at the first insulator 20.

For example, the first groove part 27 may penetrate the second bottom wall 25 in the up-down direction, and the edge part of the first extension part 45 at the tip end in the third direction may contact the circuit board CB1. At this time, the edge part of the first extension part 45 at the tip end in the third direction may serve as a mount part with respect to the circuit board CB1.

In the description of the foregoing embodiment, the first end-surface part 44 is parallel to the second bottom wall 25, but is not limited thereto. The first end-surface part 44 may be inclined obliquely to the second bottom wall 25. For example, the first end-surface part 44 may be inclined obliquely downwardly from the outer side to the inner side in the second direction. Therefore, the connector module 1 achieves effects related to the aforementioned leading and guiding.

In the description of the foregoing embodiment, the third side wall 81 is disposed continuously with the second end-surface part 84, but is not limited thereto. The third side wall 81 may not be disposed continuously with the second end-surface part 84. For example, the second shield member 80 may not include the first curved-surface part 81a.

In the description of the foregoing embodiment, the third side wall 81 extends in the third direction from the second end-surface part 84 at the outer side in the second direction, but is not limited thereto. The third side wall 81 may extend in the third direction from the second end-surface part 84 at the inner side in the second direction.

In the description of the foregoing embodiment, the second shield member 80 includes the second extension part 85 extending in the third direction from the second end-surface part 84 at the inner side in the second direction, but is not limited thereto. The second shield member 80 may not include such a second extension part 85.

In the description of the foregoing embodiment, the third side wall 81 and the second extension part 85 extend from the second end-surface part 84 at the outer side in the second direction and at the inner side in the second direction, respectively, but are not limited thereto. At least one of the third side wall 81 or the second extension part 85 may not be disposed continuously with the second end-surface part 84. For example, the second shield member 80 may not include the second curved-surface part 85a.

In the description of the foregoing embodiment, the second extension part 85 includes the second curved-surface part 85a connected to the second end-surface part 84 and having a rounded shape, but is not limited thereto. The second curved-surface part 85a may be formed based on another curved surface different from the rounded shape. The second extension part 85 and the second end-surface part 84 may be connected to one another with an inclined surface instead of the curved surface.

In the description of the foregoing embodiment, the second insulator 60 includes the second groove part 66a recessed in the third direction at the transverse wall 62a and including the space surrounded by the transverse wall 62a and the longitudinal wall 62b, but is not limited thereto. The second insulator 60 may not include such a second groove part 66a.

In the description of the foregoing embodiment, the edge part of the second extension part 85 in the first direction is accommodated in the second groove part 66a and is surrounded by the transverse wall 62a and the longitudinal wall 62b, but is not limited thereto. The edge part of the second extension part 85 in the first direction may not be accommodated in the second groove part 66a while the second groove part 66a is disposed at the second insulator 60. The edge part may simply be positioned in the recess 66 while the second groove part 66a is not disposed at the second insulator 60.

In the description of the foregoing embodiment, as illustrated in FIG. 12, an edge part of the second extension part 85 at a tip end in the third direction is not accommodated in a groove part positioned at an end part of the recess 66 at the bottom plate part 61 side, but is not limited thereto. As with the first shield member 40 of the first connector 10, the edge part of the second extension part 85 at the tip end in the third direction may be accommodated in a groove part positioned at the end part of the recess 66 at the bottom plate part 61 side.

For example, the groove part positioned at the end part of the recess 66 at the bottom plate part 61 side may penetrate the bottom plate part 61 in the up-down direction, and the edge part of the second extension part 85 at the tip end in the third direction may contact the circuit board CB2. At this time, the edge part of the second extension part 85 at the tip end in the third direction may serve as a mount part with respect to the circuit board CB2.

In the description of the foregoing embodiment, the second end-surface part 84 is parallel to the bottom plate part 61, but is not limited thereto. The second end-surface part 84 may incline obliquely to the bottom plate part 61. For example, the second end-surface part 84 may incline obliquely upwardly from the outer side to the inner side in the second direction. Therefore, the connector module 1 achieves effects related to the aforementioned leading and guiding.

In the description of the foregoing embodiment, the second side wall 42 is disposed continuously with the first end-surface part 44, but is not limited thereto. The second side wall 42 may not be disposed continuously with the first end-surface part 44. For example, the first shield member 40 may not include the third curved-surface part 47.

In the description of the foregoing embodiment, both of the pair of second side walls 42 are disposed continuously with the first end-surface part 44, but are not limited thereto. At least one of the pair of second side walls 42 may not be disposed continuously with the first end-surface part 44. For example, the first shield member 40 may not include the third curved-surface part 47 at at least one of the pair of second side walls 42.

In the description of the foregoing embodiment, the first shield member 40 includes the folded part 43 folded from the second side wall 42 toward the first side wall 41, but is not limited thereto. The first shield member 40 may not include such a folded part 43.

In the description of the foregoing embodiment, the first shield member 40 includes the pair of folded parts 43 folded from the respective ones of the pair of second side walls 42 toward the first side wall 41, but is not limited thereto. The first shield member 40 may not include the folded part 43 at at least one of the pair of second side walls 42.

In the description of the foregoing embodiment, the fracture surface of the folded part 43 and the fracture surface of the first side wall 41 are opposed to one another without the first insulator 20 interposed therebetween, but are not limited thereto. The first insulator 20 may be interposed between the fracture surface of the folded part 43 and the fracture surface of the first side wall 41.

In the description of the foregoing embodiment, the first shield member 40 includes the plurality of cutout parts 46a, but is not limited thereto. The first shield member 40 may not include such cutout parts 46a.

In the description of the foregoing embodiment, the length of the engagement part 48 in the third direction is shorter than the length of the cutout parts 46a in the second direction, but is not limited thereto. The length of the engagement parts 48 in the third direction may be equal to or more than the length of the cutout parts 46a in the second direction.

The foregoing variations related to the first shield member 40 are applicable in the same and/or similar manner to the components corresponding to the second shield member 80.

In the description of the foregoing embodiment, the first insulator 20 includes the coupling parts 20c extending in the first direction and coupling the first portion 20a to the second portion 20b, but is not limited thereto. The first insulator 20 may not include such coupling parts 20c.

In the description of the foregoing embodiment, the second shield member 80 includes the cutout parts 86, but is not limited thereto. The second shield member 80 may not include such cutout parts 86.

In the description of the foregoing embodiment, the first direction and the second direction are the transverse direction and the longitudinal direction, respectively, of the connector module 1, but are not limited thereto. The first direction may be the longitudinal direction of connector module 1 and the second direction may be the transverse direction of the connector module 1.

The connector module 1 as described above is mounted on an electronic device including the circuit board CB1 and the circuit board CB2. Examples of the electronic device include communication terminal devices such as a game machine and a smartphone, wearable machines such as a smartwatch, wireless earphones, and smartglasses, and information processing machines such as a personal computer, a copier, a printer, a facsimile, and a multifunctional machine. In addition, examples of the electronic device include any industrial equipment.

Such an electronic device can achieve in the connector module 1 a shield structure that facilitates fitting work between connectors.

Some of the embodiments of the present disclosure are illustrated below. However, note that embodiments of the present disclosure are not limited to those described below.
[Appendix 1]
   A connector module including: a first connector and a second connector opposed to one another when fitted together, wherein the first connector includes: a first insulator to be fitted to the second connector; a plurality of first contacts attached to the first insulator; and a first shield member attached to the first insulator, the second connector includes: a second insulator to be fitted to the first connector; a plurality of second contacts attached to the second insulator; and a second shield member attached to the second insulator, the first shield member includes: a pair of first side walls extending in a first direction; a pair of second side walls extending in a second direction intersecting with the first direction; and a first end-surface part including a surface extending along each of the pair of first side walls and facing toward a second connector side when the first connector and the second connector are fitted together while being opposed to one another, the second shield member includes: a pair of third side walls extending in the first direction; a pair of fourth side walls extending in the second direction; and a second end-surface part including a surface extending along each of the pair of third side walls and facing toward a first connector side when the first connector and the second connector are fitted together while being opposed to one another, and while the first connector and the second connector are opposed to one another when fitted together, the first end-surface part is positioned at the second connector side with respect to a first end part at the second connector side of each of the pair of second side walls, and the second end-surface part is positioned at the first connector side with respect to a second end part at the first connector side of each of the pair of fourth side walls.
[Appendix 2]
   The connector module according to Appendix 1, wherein each of the pair of first side walls is disposed continuously with the first end-surface part.
[Appendix 3]
   The connector module according to Appendix 2, wherein each of the pair of first side walls extends in a third direction from the first end-surface part at an outer side in the second direction facing away from a center of the first connector, the third direction intersecting with the first direction and the second direction, and the first shield member further includes a first extension part extending in the third direction from the first end-surface part at an inner side in the second direction facing toward the center.
[Appendix 4]
   The connector module according to Appendix 3, wherein the first extension part includes a curved-surface part connected to the first end-surface part.
[Appendix 5]
   The connector module according to Appendix 3 or 4, wherein the first insulator includes a bottom wall and a first groove part recessed from a surface of the bottom wall toward a side opposite to the second connector side, and an edge part of the first extension part at a tip end in the third direction is accommodated in the first groove part.
[Appendix 6]
   The connector module according to any one of Appendices 1 to 5, wherein each of the pair of third side walls is disposed continuously with the second end-surface part.
[Appendix 7]
   The connector module according to Appendix 6, wherein each of the pair of third side walls extends in a third direction from the second end-surface part at an outer side in the second direction facing away from a center of the second connector, the third direction intersecting with the first direction and the second direction, and the second shield member further includes a second extension part extending in the third direction from the second end-surface part at an inner side in the second direction facing toward the center.
[Appendix 8]
   The connector module according to Appendix 7, wherein the second extension part includes a curved-surface part connected to the second end-surface part.
[Appendix 9]
   The connector module according to Appendix 7 or 8, wherein the second insulator includes: a transverse wall extending in the first direction; a longitudinal wall extending in the second direction; and a second groove part recessed in the third direction at the transverse wall and including a space surrounded by the transverse wall and the longitudinal wall, and an edge part of the second extension part in the first direction is accommodated in the second groove part and is surrounded by the transverse wall and the longitudinal wall.
[Appendix 10]
   The connector module according to any one of Appendices 1 to 9, wherein each of the pair of second side walls is disposed continuously with the first end-surface part, and the first shield member includes a folded part folded from each of the pair of second side walls toward a corresponding one of the pair of first side walls.
[Appendix 11]
   The connector module according to Appendix 10, wherein a fracture surface of the folded part and a fracture surface of the corresponding one of the pair of first side walls are opposed to one another without the first insulator interposed therebetween.
[Appendix 12]
   The connector module according to any one of Appendices 1 to 11, wherein the first shield member includes a plurality of first cutout parts formed by cutting the first end part toward a side opposite to the second connector side.
[Appendix 13]
   The connector module according to Appendix 12, wherein the first shield member includes an engagement part extending in a third direction from the first end-surface part at an inner side in the second direction facing toward a center of the first connector, the third direction intersecting with the first direction and the second direction, and a length of the engagement part in the third direction is shorter than a length of each of the plurality of first cutout parts in the second direction.
[Appendix 14]
   The connector module according to any one of Appendices 1 to 13, wherein the first insulator includes: a first portion to which the plurality of first contacts is attached; a second portion positioned on an outer side of the first portion in the second direction and to which the first shield member is attached; and a coupling part extending in the first direction and coupling the first portion to the second portion.
[Appendix 15]
   The connector module according to Appendix 14, wherein the second shield member includes a second cutout part within which the coupling part is positioned while the first connector and the second connector are fitted to one another.
[Appendix 16]
   The connector module according to any one of Appendices 1 to 15, wherein the first direction is a transverse direction of the connector module, and the second direction is a longitudinal direction of the connector module.
[Appendix 17]
   An electronic device including: the connector module according to any one of Appendices 1 to 16.

### REFERENCE SIGNS

1 connector module
10 first connector
20 first insulator
20a first portion
20b second portion
20c coupling part
21 first bottom wall
22 fit protrusion
23 longitudinal wall
24 first contact attachment groove
25 second bottom wall (bottom wall)
26 outer peripheral wall
26a transverse wall
26b outer wall
27 first groove part
28 recess
29 attachment groove
30 first contact
31 mount part
32 engagement part
33 elastic contact piece
34 contact part
40 first shield member
41 first side wall
41a first curved-surface part
42 second side wall
42a elastic contact piece
42b second recess
43 folded part
44 first end-surface part
45 first extension part
45a second curved-surface part (curved-surface part)
45b first recess
46a cutout part (first cutout part)
46b cutout part
47 third curved-surface part
48 engagement part
49a first mount part
49b second mount part
49c third mount part
50 second connector
60 second insulator
61 bottom plate part
62 outer peripheral wall
62a transverse wall
62b longitudinal wall
63 fit recess
64 second contact attachment groove
65 attachment groove
66 recess
66a second groove part
70 second contact
71 mount part
72 first engagement part
73 folded part
74 contact part
75 second engagement part
80 second shield member
81 third side wall
81a first curved-surface part
81b first protrusion
82 fourth side wall
82a second protrusion
83 folded part
84 second end-surface part
85 second extension part
85a second curved-surface part (curved-surface part)
86 cutout part (second cutout part)
87 third curved-surface part
88 engagement part
89a first mount part
89b second mount part
89c third mount part
CB1 circuit board
CB2 circuit board

1. A connector module comprising:
a first connector and a second connector opposed to one another when fitted together, wherein
the first connector comprises:
a first insulator to be fitted to the second connector;
a plurality of first contacts attached to the first insulator; and
a first shield member attached to the first insulator,
the second connector comprises:
a second insulator to be fitted to the first connector;
a plurality of second contacts attached to the second insulator; and
a second shield member attached to the second insulator,
the first shield member comprises:
a pair of first side walls extending in a first direction;
a pair of second side walls extending in a second direction intersecting with the first direction; and
a first end-surface part comprising a surface extending along each of the pair of first side walls and facing toward a second connector side when the first connector and the second connector are fitted together while being opposed to one another,
the second shield member comprises:
a pair of third side walls extending in the first direction;
a pair of fourth side walls extending in the second direction; and
a second end-surface part comprising a surface extending along each of the pair of third side walls and facing toward a first connector side when the first connector and the second connector are fitted together while being opposed to one another, and
while the first connector and the second connector are opposed to one another when fitted together,
the first end-surface part is positioned at the second connector side with respect to a first end part at the second connector side of each of the pair of second side walls, and
the second end-surface part is positioned at the first connector side with respect to a second end part at the first connector side of each of the pair of fourth side walls.

2. The connector module according to claim 1, wherein
each of the pair of first side walls is disposed continuously with the first end-surface part.

3. The connector module according to claim 2, wherein
each of the pair of first side walls extends in a third direction from the first end-surface part at an outer side in the second direction facing away from a center of the first connector, the third direction intersecting with the first direction and the second direction, and
the first shield member further comprises a first extension part extending in the third direction from the first end-surface part at an inner side in the second direction facing toward the center.

4. The connector module according to claim 3, wherein
the first extension part comprises a curved-surface part connected to the first end-surface part.

5. The connector module according to claim 3, wherein
the first insulator comprises a bottom wall and a first groove part recessed from a surface of the bottom wall toward a side opposite to the second connector side, and
an edge part of the first extension part at a tip end in the third direction is accommodated in the first groove part.

6. The connector module according to claim 1, wherein
each of the pair of third side walls is disposed continuously with the second end-surface part.

7. The connector module according to claim 6, wherein
each of the pair of third side walls extends in a third direction from the second end-surface part at an outer side in the second direction facing away from a center of the second connector, the third direction intersecting with the first direction and the second direction, and
the second shield member further comprises a second extension part extending in the third direction from the second end-surface part at an inner side in the second direction facing toward the center.

8. The connector module according to claim 7, wherein
the second extension part comprises a curved-surface part connected to the second end-surface part.

9. The connector module according to claim 7, wherein
the second insulator comprises:
a transverse wall extending in the first direction;
a longitudinal wall extending in the second direction; and
a second groove part recessed in the third direction at the transverse wall and comprising a space surrounded by the transverse wall and the longitudinal wall, and
an edge part of the second extension part in the first direction is accommodated in the second groove part and is surrounded by the transverse wall and the longitudinal wall.

10. The connector module according to claim 1, wherein
each of the pair of second side walls is disposed continuously with the first end-surface part, and
the first shield member comprises a folded part folded from each of the pair of second side walls toward a corresponding one of the pair of first side walls.

11. The connector module according to claim 10, wherein
a fracture surface of the folded part and a fracture surface of the corresponding one of the pair of first side walls are opposed to one another without the first insulator interposed therebetween.

12. The connector module according to claim 1, wherein
the first shield member comprises a plurality of first cutout parts formed by cutting the first end part toward a side opposite to the second connector side.

13. The connector module according to claim 12, wherein
the first shield member comprises an engagement part extending in a third direction from the first end-surface part at an inner side in the second direction facing toward a center of the first connector, the third direction intersecting with the first direction and the second direction, and
a length of the engagement part in the third direction is shorter than a length of each of the plurality of first cutout parts in the second direction.

14. The connector module according to claim 1, wherein
the first insulator comprises:
a first portion to which the plurality of first contacts is attached;
a second portion positioned on an outer side of the first portion in the second direction and to which the first shield member is attached; and
a coupling part extending in the first direction and coupling the first portion to the second portion.

15. The connector module according to claim 14, wherein
the second shield member comprises a second cutout part within which the coupling part is positioned while the first connector and the second connector are fitted to one another.

16. The connector module according to claim 1, wherein
the first direction is a transverse direction of the connector module, and
the second direction is a longitudinal direction of the connector module.

17. An electronic device comprising:
the connector module according to claim 1.
